(19) United States
(12) Patent Application Publication
(10) Pub. No.: US 2022/0025179 A1
(43) Pub. Date: Jan. 27, 2022

(54) CURABLE SILICONE COMPOSITION, AND LIGHT DIFFUSION MATERIAL FORMED THEREBY

(71) Applicant: DOW SILICONES CORPORATION, Midland, MI (US)

(72) Inventors: Donald A. KADLEC, Midland, MI (US); Bradley W. TUFT, Midland, MI (US)

(21) Appl. No.: 17/277,367

(22) PCT Filed: Sep. 19, 2019
(86) PCT No.: PCT/US2019/051818

§ 371 Date: Mar. 18, 2021

Related U.S. Application Data
(60) Provisional application No. 62/733,999, filed on Sep. 20, 2018.

(51) Int. Cl. C08L 83/04; C08G 77/12; C08G 77/20; C08G 77/08; C08G 77/24; G02B 1/04; G02B 5/02; C08G 77/00

(52) U.S. Cl. CPC C08L 83/04; C08G 77/12; C08G 77/20; C08G 77/70; C08G 77/24; G02B 1/04; G02B 5/0268; C08G 77/08

(57) ABSTRACT

A curable silicone composition for forming a light diffusion material is disclosed. The curable silicone composition comprises: (A) an organopolysiloxane having at least two alkenyl groups per molecule and free of a fluoro-containing organic group; (B) an organopolysiloxane having at least two silicon atom-bonded hydrogen atoms per molecule and free of a fluoro-containing organic group; (C) an organopolysiloxane having at least one fluoro-containing organic group per molecule; and (D) a hydrosilylation reaction catalyst. The curable silicone composition can be cured to form a light diffusion material exhibiting good to excellent transparency and diffusion properties.

### CROSS REFERENCE TO RELATED APPLICATIONS

The application claims priority to and all advantages of U.S. Provisional Patent Application No. 62/733,999 filed on 20 Sep. 2018, the content of which is incorporated herein by reference.

### TECHNICAL FIELD

The present invention generally relates to a curable silicone composition for forming a light diffusion material, and a light diffusion material formed thereby Background Art

Light diffusion materials are understood in the art and are utilized in various optical device applications such as lighting devices, displays, and diffusive articles for guiding, reflecting and/or diffusing light. In general, these light diffusion materials are formed by a polymeric material comprising immiscible materials to enhance light scattering properties. The immiscible materials are dispersed to form separated domains in the polymeric material.

For example, International Publication No. WO 2018/107021 A1 discloses a composition comprising: (I) an aryl component; (II) a methyl component; and (III) a hydrosilylation catalyst, wherein component (I) comprises: an organopolysiloxane having alkenyl groups and aryl groups, and an organohydrogenpolysiloxane having silicon atom-bonded hydrogen atoms and aryl groups, and wherein component (II) comprises an organopolysiloxane having alkenyl group and methyl groups, and an organohydrogenpolysiloxane having silicon atom-bonded hydrogen atoms and methyl groups.

Such a composition can provide a light diffusion material exhibiting transparency and diffusion properties. However, the light diffusion material obtained by curing the composition is not satisfactory with respect to yellowing (Yellow Index, “YI”).

### PRIOR ART DOCUMENTS

### Patent Documents

Patent Document 1: International Publication No. WO 2018/107021 A1

### BRIEF SUMMARY OF INVENTION

### Technical Problem

An object of the present invention is to provide a curable silicone composition to form a light diffusion material exhibiting good to excellent transparency and diffusion properties. Another object of the present invention is to provide a light diffusion material exhibiting good to excellent transparency and diffusion properties.

### Solution to Problem

A curable silicone composition for forming a light diffusion material is disclosed. The curable silicone composition (“composition”) comprises:

(A) an organopolysiloxane having at least two alkenyl groups per molecule and free of a fluoro-containing organic group;
(B) an organopolysiloxane having at least two silicon atom-bonded hydrogen atoms per molecule and free of a fluoro-containing organic group, in an amount that provides about 0.8 to about 4.0 moles of silicon atom-bonded hydrogen atoms in this component per 1 mole of total alkenyl groups in component (A);
(C) an organopolysiloxane having at least one fluoro-containing organic group per molecule, in an amount of from about 1 to about 40 mass % of total mass of components (A) to (C); and
(D) a catalytic quantity of a hydrosilylation reaction catalyst.

In various embodiments, component (A) is an organopolysiloxane comprising:

(A-1) a linear or a partially branched organopolysiloxane having at least two alkenyl groups per molecule and free of a fluoro-containing organic group, and
(A-2) a resinous organopolysiloxane comprising: SiO_{4/2} units, R¹₂R²SiO_{1/2} units and R¹₃SiO_{1/2} units, wherein each R¹ is an alkyl group, R² is an alkenyl group, and a mole ratio of R¹₂R²SiO_{1/2} units and R¹₃SiO_{1/2} units per SiO_{4/2} units is in a range of from about 0.6 to about 2.0,

wherein a content of component (A-1) is in an amount of from about 50 to about 90 mass % of total mass of components (A-1) and (A-2).

In various embodiments, component (B) is a resinous organopolysiloxane comprising: SiO_{4/2} units and HR³₂SiO_{1/2} units, wherein each R³ is an alkyl group, and a mole ratio of HR³₂SiO_{1/2} units per SiO_{4/2} units is in a range of from about 1.5 to about 2.5.

In various embodiments, component (C) is an organopolysiloxane having at least one silicon atom-bonded hydrogen atom or alkenyl group per molecule.

In various embodiments, the curable silicone composition further comprises: (E) a hydrosilylation reaction inhibitor, in a sufficient amount to control a curing property of the composition.

The light diffusion material of the present invention is obtained by curing the curable silicone composition as described above.

### Effects of Invention

The curable silicone composition of the present invention can be cured to form a light diffusion material exhibiting good to excellent transparency and diffusion properties. In addition, the light diffusion material of the present invention exhibits good to excellent transparency and diffusion properties.

### Definitions

The terms “comprising” or “comprise” are used herein in their broadest sense to mean and encompass the notions of “including,” “include,” “consist(ing) essentially of,” and “consist(ing) of”. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

It is to be understood that the appended claims are not limited to express and particular compounds, compositions, or methods described in the detailed description, which may vary between particular embodiments which fall within the scope of the appended claims.

With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

### DETAILED DESCRIPTION OF THE INVENTION

First, the curable silicone composition of the present invention will be explained in detail.

Component (A) is an organopolysiloxane having at least two alkenyl groups per molecule and free of a fluoro-containing organic group. Examples of the alkenyl groups include alkenyl groups having from 2 to 12 carbon atoms such as vinyl groups, allyl groups, butenyl groups, pentenyl groups, hexenyl groups, heptenyl groups, octenyl groups, nonenyl groups, decenyl groups, undecenyl groups, and dodecenyl groups. In certain embodiments, the alkenyl groups are vinyl groups. In addition, examples of groups bonding to silicon atoms other than alkenyl groups in component (A) include: alkyl groups having from 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups, and dodecyl groups; aryl groups having from 6 to 12 carbon atoms such as phenyl groups, tolyl groups, xylyl groups, and naphthyl groups; aralky groups having from 7 to 12 carbon atoms such as benzyl groups, and phenethyl groups. In certain embodiments, groups bonding to silicon atoms other than alkenyl groups in component (A) are alkyl groups. Furthermore, the silicon atoms in component (A) may have small amounts of hydroxyl groups or alkoxy groups such as methoxy groups or ethoxy groups within a range that does not impair the object of the present invention.

Examples of the molecular structure of component (A) include a linear structure, a partially branched chain structure, a branched chain structure, a cyclic structure, and a resinous structure. Component (A) may be one type of organopolysiloxane having these molecular structures or may be a mixture of two or more types of organopolysiloxanes having these molecular structures.

In various embodiments, component (A) is a mixture of (A-1) a linear or a partially branched organopolysiloxane having at least two alkenyl groups per molecule and free of a fluoro-containing organic group, and (A-2) a resinous organopolysiloxane comprising, alternatively consisting essentially of, alternatively consisting of, SiO_{4/2} units, R¹₂R²SiO_{1/2} units, and R¹₃SiO_{1/2} units.

The alkenyl groups in component (A-1) are exemplified by alkenyl groups having from 2 to 12 carbon atoms such as vinyl groups, allyl groups, butenyl groups, pentenyl groups, hexenyl groups, heptenyl groups, octenyl groups, nonenyl groups, decenyl groups, undecenyl groups, and dodecenyl groups. In certain embodiments, vinyl groups and/or allyl groups are present. Silicon atom-bonded groups other than the alkenyl groups in component (A-1) are exemplified by: alkyl groups having from 1 to 12 carbon atoms, such as methyl groups, ethyl groups, propyl groups, butyl groups, pentyl groups, hexyl groups, heptyl groups, octyl groups, nonyl groups, decyl groups, undecyl groups, and dodecyl groups; aryl groups having from 6 to 12 carbon atoms such as phenyl groups, tolyl groups, xylyl groups, and naphthyl groups; and aralky groups having from 7 to 12 carbon atoms such as benzyl groups, and phenethyl groups. In certain embodiments, alkyl groups are present.

Component (A-1) has a substantially straight chain molecular structure, but a portion of the molecular chain may be branched or somewhat branched. The viscosity of component (A-1) at 25° C. is not limited, but in various embodiments is in the range of from about 100 mPa·s to about 100,000 mPa·s, alternatively in the range of from about 200 mPa·s to about 50,000 mPa·s, alternatively in the range of from about 300 mPa·s to about 50,000 mPa·s. The reasons for the preceding are as follows: when the viscosity of component (A-1) at 25° C. is less than the lower limit cited above, the light diffusion material provided by curing the composition tends to have an unsatisfactory flexibility; when, on the other hand, the viscosity of component (A-1) at 25° C. exceeds the upper limit cited above, the composition assumes an excessively high viscosity in processing and handling. Note that in the present specification, viscosity is the value measured using a type B viscometer according to ASTM D 1084 at 23±2° C.

Examples of component (A-1) include dimethylpolysiloxanes capped at both molecular terminals with dimethylvinylsiloxy groups, dimethylsiloxane-methylvinylsiloxane copolymers capped at both molecular terminals with dimethylvinylsiloxy groups, dimethylsiloxane-methylvinylsiloxane copolymers capped at both molecular terminals with trimethylsiloxy groups, dimethylsiloxane-methylvinylsiloxane-methylphenylsiloxane copolymers capped at both molecular terminals with trimethylsiloxy groups, a mixture of dimethylpolysiloxanes capped at both molecular terminals with dimethylvinylsiloxy groups, and dimethylpolysiloxane capped at one molecular terminal with dimethylvinylsiloxy group and at another molecular terminal with dimethylhydroxysiloxy group, a mixture of dimethylpolysiloxanes capped at both molecular terminals with dimethylvinylsiloxy groups, and dimethylpolysiloxane capped at both molecular terminals with dimethylhydroxysiloxy group, and mixtures of two or more types thereof.

Component (A-2) is a resinous organopolysiloxane comprising, alternatively consisting essentially of, alternatively consisting of, SiO_{4/2} units, R¹₂R²SiO_{1/2} units, and R¹₃SiO_{1/2} units, and is used to impart a satisfactory hardness and flexibility to the light diffusion material provided by curing the composition.

In the formula, each R¹ independently is an alkyl group. The alkyl groups for R¹ are exemplified by alkyl groups having from 1 to 12 carbon atoms such as methyl groups, ethyl groups, propyl groups, butyl groups, pentyl groups, hexyl groups, heptyl groups, octyl groups, nonyl groups, decyl groups, undecyl groups, and dodecyl groups. In certain embodiments, methyl groups are present.

In the formula, each R² independently is an alkenyl group. The alkenyl groups for R² are exemplified by alkenyl groups having from 2 to 12 carbon atoms such as vinyl groups, allyl groups, butenyl groups, pentenyl groups, hexenyl groups, heptenyl groups, octenyl groups, nonenyl groups, decenyl groups, undecenyl groups, and dodecenyl groups. In certain embodiments, vinyl groups and/or allyl groups are present.

An alkenyl group content of component (A-2) is not limited, but in various embodiments it is in a range of from about 0.5 to about 5.0 mass %, alternatively in a range of from about 0.5 to about 4.5 mass %, alternatively in a range of from about 0.5 to about 4.0 mass %, alternatively in a range of from about 1.0 to about 5.0 mass %, alternatively in a range of from about 1.0 to about 4.0 mass %. The reasons for this are as follows: when the alkenyl group content is less than the cited lower limit, the hardness of the light diffusion material provided by curing the composition tends to decline; when, on the other hand, the alkenyl group content exceeds the cited upper limit, the flexibility of the light diffusion material provided by curing the composition tends to decline.

In various embodiments, the ratio of the total number of moles of R¹₂R²SiO_{1/2} and R¹₃SiO_{1/2} units to 1 mole of the SiO_{4/2} unit in component (A-2) is in the range of from about 0.6 to about 2.0, alternatively in the range of from about 0.6 to about 1.5, alternatively in the range of from about 0.6 to about 1.0. The reasons for this are as follows: when the ratio is less than the cited lower limit, component (A-2) takes on an excessively large molecular weight and the transparency of the light diffusion material provided by curing the composition may decline; when, on the other hand, the ratio exceeds the upper limit cited above, the light diffusion material provided by curing the composition may have an unsatisfactory strength.

In various embodiments, the content of component (A-1) is in a range of from about 50 to about 90 mass % of total mass of components (A-1) and (A-2), alternatively in a range of from about 50 to about 85 mass %, alternatively in a range of from about 50 to about 80 mass %. The reasons for this are as follows: when the content is less than the lower limit on the cited range, the flexibility of the light diffusion material provided by curing the composition tends to decline; when, on the other hand, the content exceeds the upper limit on the cited range, the hardness of the light diffusion material provided by curing the composition tends to decline.

Component (B) is an organohydrogenpolysiloxane having at least two silicon-bonded hydrogen atoms per molecule and free of a fluoro-containing organic group. Examples of groups bonding to silicon atoms other than hydrogen groups in component (B) include: alkyl groups having from 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups, and dodecyl groups; aryl groups having from 6 to 12 carbon atoms such as phenyl groups, tolyl groups, xylyl groups, and naphthyl groups; and aralky groups having from 7 to 12 carbon atoms such as benzyl groups, and phenethyl groups. In certain embodiments, alkyl groups are present. Furthermore, the silicon atoms in component (B) may have small amounts of hydroxyl groups or alkoxy groups such as methoxy groups or ethoxy groups within a range that does not impair the object of the present invention.

Examples of the molecular structure of component (B) include a linear structure, a partially branched chain structure, a branched chain structure, a cyclic structure, and a resinous structure. Component (B) may be one type of organopolysiloxane having these molecular structures or may be a mixture of two or more types of organopolysiloxanes having these molecular structures.

In various embodiments, component (B) is a resinous organopolysiloxane comprising, alternatively consisting essentially of, alternatively consisting of, SiO_{4/2} units and HR³₂SiO_{1/2} units.

In the formula, each R³ independently is an alkyl group. The alkyl groups for R¹ are exemplified by alkyl groups having from 1 to 12 carbon atoms such as methyl groups, ethyl groups, propyl groups, butyl groups, pentyl groups, hexyl groups, heptyl groups, octyl groups, nonyl groups, decyl groups, undecyl groups, and dodecyl groups. In certain embodiments, methyl groups are present.

In the formula, a ratio of the total number of moles of the HR³₂SiO_{1/2} units to 1 mole of the SiO_{4/2} units in various embodiments is in a range of from about 1.5 to about 2.5, alternatively in a range of from about 1.5 to about 2.0. The reasons for this are as follows: when the ratio is less than the cited lower limit, the organopolysiloxane takes on an excessively large molecular weight and the transparency of the light diffusion material provided by curing the composition may decline; when, on the other hand, the ratio exceeds the upper limit cited above, the light diffusion material provided by curing the composition may have an unsatisfactory strength.

Component (B) may comprise a linear or partially branched organopolysiloxane having at least two silicon atom-bonded hydrogen atoms per molecule and free of a fluoro-containing organic group. There are no limitations on the bonding position of the silicon atom-bonded hydrogen atoms in the organopolysiloxane, and the silicon atom-bonded hydrogen atoms may be bonded in, for example, terminal position on the molecular chain and/or side chain position on the molecular chain. Silicon atom-bonded groups other than hydrogen atoms in the organopolysiloxane are exemplified by the alkyl groups as described above for R¹. In certain embodiments, methyl groups are present. While there is no limitation on the viscosity of the organopolysiloxane, in certain embodiments its viscosity at 25° C. is in the range of from 1 to 1,000 mm²/s, alternatively is in the range of from 1 to 100 mm²/s.

The organopolysiloxanes for component (B) are exemplified by linear copolymers of dimethylsiloxane and methylhydrogensiloxane endblocked at both molecular chain terminals with dimethylhydrogensiloxy groups, partially branched copolymers of dimethylsiloxane and methylhydrogensiloxane endblocked at molecular chain terminals with dimethylhydrogensiloxy groups, linear methylhydrogenpolysiloxanes endblocked at both molecular chain terminals with trimethylsiloxy groups, partially branched methylhydrogenpolysiloxanes endblocked at molecular chain terminals with trimethylsiloxy groups, linear copolymers of dimethylsiloxane and methylhydrogensiloxane endblocked at both molecular chain terminals with trimethylsiloxy groups, partially branched copolymers of dimethylsiloxane and methylhydrogensiloxane endblocked at molecular chain terminals with trimethylsiloxy groups, copolymers of dimethylsiloxane and methylhydrogensiloxane endblocked at both molecular chain terminals with dimethylhydrogensiloxy groups, dimethylpolysiloxanes endblocked at both molecular chain terminals with dimethylhydrogensiloxy groups, and mixtures of two or more of the preceding.

The content of component (B) in the composition is an amount that provides from about 0.8 to about 4.0 moles, alternatively from about 0.8 to about 3.5 moles, alternatively from about 0.8 to about 3 moles of the silicon atom-bonded hydrogen atoms in this component per 1 mole of the alkenyl groups in component (A). The reasons for this are as follows: when the content is less than the lower limit for the cited range, curing of the composition tends to be unsatisfactory; when, on the other hand, the upper limit for the cited range is exceeded, the flexibility and/or transparency of the light diffusion material provided by curing the composition may be diminished.

Component (C) is an organopolysiloxane having at least one fluoro-containing organic group per molecule. Examples of the fluoro-containing organic groups include: perfluoroalkyl groups such as trifluoropropyl groups, pentafluorobutyl groups, heptafluoropentyl groups, tridecafluorooctyl groups, heptadecafluorodecyl groups, and nonafluorobutylethyl groups; perfluoroalkylether groups represented by the following general formula:

F(CF₂CF₂O)ₘ(CF₂O)ₙCF₂C(═O)OC₃H₆—,

wherein “m” and “n” are each independently a number, and are 0 or more, an integer of 200 or less, alternatively 10 or more, and an integer of 100 or less. In addition, examples of groups bonding to silicon atoms other than fluoro-containing organic groups in component (C) include: alkyl groups having from 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups, and dodecyl groups; vinyl groups, allyl groups, butenyl groups, pentenyl groups, hexenyl groups, heptenyl groups, octenyl groups, nonenyl groups, decenyl groups, undecenyl groups, and dodecenyl groups; aryl groups having from 6 to 20 carbon atoms such as phenyl groups, tolyl groups, xylyl groups, and naphthyl groups. In certain embodiments, at least one of alkyl groups, alkenyl groups, or hydrogen atoms are present. Furthermore, the silicon atoms in component (C) may have small amounts of hydroxyl groups or alkoxy groups such as methoxy groups or ethoxy groups within a range that does not impair the object of the present invention.

Examples of the molecular structure of component (C) include a linear structure, a partially branched chain structure, a branched chain structure, a cyclic structure, and a resinous structure. Component (C) may be one type of organopolysiloxane having these molecular structures or may be a mixture of two or more types of organopolysiloxanes having these molecular structures.

The organopolysiloxanes for component (C) are exemplified by linear copolymers of dimethylsiloxane and methyl(trifluoropropyl)siloxane endblocked at both molecular chain terminals with dimethylhydrogensiloxy groups, linear copolymers of dimethylsiloxane and methyl(trifluoropropyl)siloxane endblocked at both molecular chain terminals with dimethylvinylsiloxy groups, partially branched copolymers of dimethylsiloxane and methyl(trifluoropropyl)siloxane endblocked at molecular chain terminals with dimethylhydrogensiloxy groups, partially branched copolymers of dimethylsiloxane and methyl(trifluoropropyl)siloxane endblocked at molecular chain terminals with dimethylvinylsiloxy groups, linear methyl(trifluoropropyl)polysiloxanes endblocked at both molecular chain terminals with trimethylsiloxy groups, linear methyl(trifluoropropyl)polysiloxanes endblocked at both molecular chain terminals with dimethylvinylsiloxy groups, partially branched methyl(trifluoropropyl)polysiloxanes endblocked at molecular chain terminals with trimethylsiloxy groups, linear copolymers of methyl(perfluorobutylethyl)siloxane and methylhydrogensiloxane endblocked by trimethylsiloxy groups at both molecular chain terminals, and mixtures of two or more of the preceding.

The content of component (C) in the composition is not limited, but in various embodiments is in an amount of from about 1 to about 40 mass % of total mass of components (A) and (C), alternatively in an amount of from about 1 to about 30 mass %, alternatively in an amount of from about 1 to about 20 mass %, alternatively in an amount of from about 1 to about 10 mass %. The reasons for this are as follows: when the content is less than the lower limit on the cited range, the diffusion properties of the light diffusion material provided by curing the composition tends to decline; when, on the other hand, the content exceeds the upper limit on the cited range, the hardness of the light diffusion material provided by curing the composition tends to decline.

Component (D) is a hydrosilylation reaction catalyst, and promotes curing of the composition. The hydrosilylation reaction catalysts for component (D) are exemplified by platinum-type catalysts, rhodium-type catalysts, and palladium-type catalysts. In various embodiments, component (D) comprises or is at least one platinum-type catalyst. These platinum-type catalysts are exemplified by platinum micropowder, platinum black, platinum supported on silica micropowder, platinum supported on active carbon, chloroplatinic acid, alcohol solutions of chloroplatinic acid, and platinum compounds such as olefin complexes of platinum, alkenylsiloxane complexes of platinum, and the like.

The content of component (D) in the composition is a catalytic quantity and in specific terms is a quantity that provides about 0.01 to about 1,000 mass-ppm catalyst metal atoms with reference to the composition. The reasons for this are as follows: when the content is less than the lower limit for the cited range, the risk arises that the cure of the resulting composition will not proceed adequately; on the other hand, curing is not significantly promoted by exceeding the upper limit for the cited range, while the risk arises that problems will appear such as discoloration of the light diffusion material.

The composition may further comprise (E) a hydrosilylation reaction inhibitor in order to adjust the cure rate of the composition. The hydrosilylation reaction inhibitors for component (E) are exemplified by alkyne alcohols such as 2-methyl-3-butyn-2-ol, 3,5-dimethyl-1-hexyn-3-ol, 1-ethynylcyclohexan-1-ol, and 2-phenyl-3-butyn-2-ol; ene-yne compounds such as 3-methyl-3-penten-1-yne, and 3,5-dimethyl-3-hexen-1-yne; as well as 1,3,5,7-tetramethyl-1,3,5,7-tetravinylcyclotetrasiloxane, and 1,3,5,7-tetramethyl-1,3,5,7-tetrahexenylcyclotetrasiloxane, benzotriazole, and the like.

There is no limitation on the content of component (E) in the composition, and this content may be selected as appropriate as a function of a molding method and/or curing conditions; however, an amount within the range from about 0.001 to about 5 parts by mass per 100 parts by mass of component (A) is utilized in certain embodiments.

The composition may further comprise an adhesion promoter. Examples of the adhesion promoter include: organosilanes or linear, branched, or cyclic organosiloxane oligomers having approximately 4 to 20 silicon atoms having a trialkoxysiloxy group (e.g., a trimethoxysiloxy group or triethoxysiloxy group) or a trialkoxysilylalkyl group (e.g., a trimethoxysilylethyl group or triethoxysilylethyl group), and a hydrosilyl group or alkenyl group (e.g., a vinyl group or allyl group); organosilanes or linear, branched, or cyclic organosiloxane oligomers having approximately 4 to 20 silicon atoms having a trialkoxysiloxy group or trialkoxysilylalkyl group, and a methacryloxyalkyl group (e.g., a 3-methacryloxypropyl group); organosilanes or linear, branched, or cyclic organosiloxane oligomers having approximately 4 to 20 silicon atoms having a trialkoxysiloxy group or trialkoxysilylalkyl group, and an epoxy group-bonded alkyl group (e.g., a 3-glycidoxypropyl group, 4-glycidoxybutyl group, 2-(3,4-epoxycyclohexyl)ethyl group, or 3-(3,4-epoxycyclohexyl)propyl group); and reaction products of aminoalkyl trialkoxysilanes and epoxy group-bonded alkyltrialkoxysilanes, and epoxy group-containing ethyl polysilicates. Specific examples of the adhesion promoters include: vinyl trimethoxysilane, allyl trimethoxysilane, allyl triethoxysilane, hydrogen triethoxysilane, 3-glycidoxypropyl trimethoxysilane, 3-glycidoxypropyl triethoxysilane, 2-(3,4-epoxy cyclohexyl)ethyl trimethoxysilane, 3-methacryloxypropyl trimethoxysilane, 3-methacryloxypropyl triethoxysilane, reaction products of 3-g lycidoxypropyl triethoxysilane and 3-aminopropyl triethoxysilane, condensation reaction products of silanol group-terminated methylvinylsiloxane oligomers and 3-glycidoxypropyl trimethoxysilane, condensation reaction products of silanol group-terminated methylvinylsiloxane oligomers and 3-methacryloxypropyl triethoxysilane, tris(3-trimethoxysilylpropyl) isocyanurate, acid anhydrides, and the like. These adhesion promoters can be low-viscosity liquids, and their viscosity at 25° C. is not particularly limited but can be from 1 to 500 mPa·s.

There is no limitation on the content of the adhesion promoter in the composition, but in various embodiments it is in an amount of not more than about 2 mass % of the composition.

The composition may further comprise a condensation catalyst. Examples of the condensation catalyst include: organotitanium compounds such as tetraisopropyl titanate, tetrabutyl titanate, tetraoctyl titanate, titanium acetic acid salts, titanium di-isopropoxy bis(acetylacetonate), titanium di-isopropoxide bis(tetramethylheptanedionate), titanium di-isopropoxide bis(2,4-pentanedionate), and titanium di-isopropoxy bis(ethyl acetoacetate);

organotin compounds such as dibutyltin dilaurate, dimethyltin dineodecanoate, dibutyltin diacetate, dimethylhydroxy(oleate)tin, and dioctyldilauryltin; organoaluminum compounds such as aluminum acetylacetonate, aluminum di-s-butoxide ethylacetoacetate, and aluminum di-isopropoxide ethylacetoacetate; organozirconium compounds such as zirconium n-butoxide, zirconium di-n-butoxide bis (2,4-pentanedionate), and zirconium 2,4-pentanedionate; organoiron compounds such as iron 2,4-pentanedionate, and iron tetramethyl heptanedionate; and organozirconium compounds such as zirconium tetraacetylacetonate, zirconium hexafluoroacetylacetonate, zirconium trifluoroacetylacetonate, tetrakis(ethyltrifluoroacetylacetonate)zirconium, tetrakis(2,2,6,6-tetramethyl-heptanedionate), zirconium dibutoxybis(ethylacetoacetate), and zirconium diisopropoxybis(2,2,6,6-tetramethyl-heptanedionate).

There is no limitation on the content of the condensation catalyst in the composition, but in various embodiments it is in an amount of not more than about 0.5 mass % of the composition.

The composition may incorporate, insofar as the object of the present invention is not impaired, for example, a flame retardant, an inorganic filler, and so forth. However, as a general matter, flame retardants and/or inorganic fillers are generally not incorporated from the perspective of the transparency of the cured silicone product provided by curing the composition. In other words, the composition can be free of such components.

In various embodiments, the composition is disposed on a substrate upon its formation to prevent phase separation or premature curing thereof. Disposing or dispensing the composition may comprise any suitable application technique. In certain embodiments, the composition is applied in wet form via a wet coating technique. In specific embodiments, the composition is applied by: i) spin coating; ii) brush coating; iii) drop coating; iv) spray coating; v) dip coating; vi) roll coating; vii) flow coating; viii) slot coating; ix) gravure coating; or x) a combination of any of i) to ix).

The composition may be cured to form a light diffusion material on a substrate. The substrate is not limited and may be any substrate. For example, the substrate may be a mold, which may optionally be heated in connection with curing the deposited material (“deposit”). A light diffusion article may be separable from the substrate or may be physically and/or chemically bonded to the substrate depending on its selection. The substrate may have an integrated hot plate or an integrated or stand-alone furnace for curing the deposit.

When the substrate is the mold, the deposit may take the shape defined by the mold. Alternatively, the deposit may be applied uniformly or non-uniformly depending on desired shape and dimension of the article formed from the deposit.

Next, the light diffusion material of the present invention will be explained in detail. The light diffusion material of the present invention is obtained by curing the curable silicone composition as described above.

The light diffusion material may be utilized in an LED or OLED or another light-emitting or light-absorbing semiconductor component. The light diffusion material can form any part of the optical device through which light is reflected and/or refracted, either with or without modification or manipulation of the light. The light diffusion material can be part of an optical integrated circuit, such as integrated circuits, such as part of an attenuator, a switch, a splitter, a router, a filter, or a grating.

A lighting device comprising the light diffusing material formed from the composition is also provided by the present invention. The lighting device may be any lighting device, e.g. a luminaire. The lighting device may rely on light from a light-emitting diode, an incandescent light, a compact fluorescent light, a halogen light, a metal halide light, a sodium vapor light, etc. The lighting device may be utilized in residential, commercial, or other applications, including in electronics applications.

### Examples

The curable silicone composition and the light diffusion material of the present invention will now be described in detail hereinafter using Practical (“Prac.”) and Comparative (“Comp.”) Examples. In the Examples, the viscosity is the value at 25° C. In the chemical formulae, “Me” represents a methyl group, and “Vi” represents a vinyl group.

The following components were used as component (A).

Component (a-1): a linear dimethylpolysiloxane endblocked at both molecular chain terminals with dimethylvinylsiloxy groups, that has a viscosity of approximately 10,000 mPa·s and a vinyl group content of 0.13 mass %.

Component (a-2): a linear dimethylpolysiloxane endblocked at both molecular chain terminals with dimethylvinylsiloxy groups, that has a viscosity of 40,000 mPa·s and a vinyl group content of 0.09 mass %.

Component (a-3): a resinous organopolysiloxane having a vinyl group content of 1.6 mass % and represented by the average unit formula:

(Me₃SiO_{1/2})_{0.40}(Me₂ViSio_{1/2})_{0.04}(Sio_{4/2})_{0.56}

The following component was used as component (B).

Component (b-1): an organopolysiloxane having a viscosity of 23 mm²/s and a silicon atom-bonded hydrogen atom content of 0.96 mass %, and represented by the average unit formula:

(Me₂HSiO_{1/2})_{0.73}(SiO_{4/2})_{0.27}

The following components were used as component (C).

Component (c-1): a methyltrifluoropropylpolysiloxane endblocked by dimethylvinylsiloxy groups at both molecular chain terminals, that has a viscosity of approximately 58,600 mm²/s.

Component (c-2): a copolymer of methyl(perfluorobutylethyl)siloxane and methylhydrogensiloxane endblocked by trimethylsiloxy groups at both molecular chain terminals, that has a viscosity of approximately 35 mm²/s.

Component (c-3): a copolymer of methyl(trifluoropropyl)siloxane and dimethylsiloxane endblocked by dimethylvinylsiloxy groups at both molecular chain terminals, that has a viscosity of approximately 800 mm²/s.

Component (c-4): a linear methyl(trifluoropropyl)polysiloxane endblocked by dimethylvinylsiloxy groups at both molecular chain terminals, that has a viscosity of approximately 700 mPa·s.

The following component was used as component (D).

Component (d-1): 1,3-divinyltetramethyl disiloxane solution of a 1,3-divinyltetramethyl disiloxane platinum complex (platinum metal content in terms of mass units in this component is approximately 5,200 ppm).

The following component was used as component (E).

Component (e-1): 3,5-dimethyl-1-hexyn-3-ol

The following component was used as component (F).

Component (f-1): a linear methylphenylpolysiloxane endblocked at both molecular chain terminals with dimethylvinylsiloxy groups, that has a viscosity of 2,000 mPa·s.

### Practical Examples 1 to 4 and Comparative Examples 1 to 2

The components shown in Table 1 below were mixed by means of a planetary mixer (Hauschild SpeedMixer DAZ 150FVZ) at 3,000 rotations per minute (rpm) for 25 secs. to uniformity in the quantity proportions shown in Table 1 to produce curable silicone compositions. “SiH/Vi” in Table 1 indicates the ratio of the number of moles of silicon atom-bonded hydrogen atoms in component (B) per 1 mole of the vinyl groups in component (A).

Light diffusion materials of the compositions were made with a Variant (now Agilent) Cary 5000 dual beam spectrophotometer with an integrating sphere attachment (ASTM D1003). The measured transmission values are not corrected for surface reflections. All samples are 1.45 mm thickness, cured for 1 hour at 150° C. The “Haze” was calculated from measured T_{Total} and T_{Diffuse} by the equation below.

$$Haze = \frac{{T}_{Diffuse}}{{T}_{Total}}$$

Yellow index (“YI”) (CIE 1931 XYZ color space) and b* (CIELAB L*a*b* color space) were calculated from transmission data in % acquired from the Cary 5000 spectrophotometer measurements (360 to 800 nm in 1 nm increments) using Colorimetry spreadsheet (1931, 2 deg observer, ASTM Method E313). The larger YI or b*, the more intense the color shift toward yellow. The results are given in Table 1 below.

TABLE 1

| | | | Category | | | | | |
|---|---|---|---|---|---|---|---|---|
| | | | Prac. | Prac. | Prac. | Prac. | Comp. | Comp. |
| | | | Example | Example | Example | Example | Example | Example |
| Item | | | 1 | 2 | 3 | 4 | 1 | 2 |
| Composition | (A) | (a-1) | 39.77 | 39.77 | 39.77 | 39.77 | 41.86 | 39.77 |
| of curable | | (a-2) | 13.02 | 13.02 | 13.02 | 13.02 | 13.71 | 13.02 |
| silicone | | (a-3) | 37.61 | 37.61 | 37.61 | 37.61 | 39.58 | 37.61 |
| composition | (B) | (b-1) | 4.37 | 4.37 | 4.37 | 4.37 | 4.60 | 4.37 |
| (parts by | (C) | (c-1) | 4.00 | — | — | — | — | — |
| mass) | | (c-2) | — | 4.00 | — | — | — | — |
| | | (c-3) | — | — | 4.00 | — | — | — |
| | | (c-4) | — | — | — | 4.00 | — | — |
| | | (c-5) | — | — | — | — | — | — |
| | (D) | (d-1) | 0.06 | 0.06 | 0.06 | 0.06 | 0.06 | 0.06 |
| | (E) | (e-1) | 0.20 | 0.20 | 0.20 | 0.20 | 0.20 | 0.20 |
| | (F) | (f-1) | — | — | — | — | — | 4.00 |

| SiH/Vi | | 1.3 | 2.2 | 1.3 | 1.3 | 1.4 | 1.3 |
|---|---|---|---|---|---|---|---|
| Light | Transmittance (%) | 85 | 93.3 | 88.6 | 75.1 | 93 | 44.26 |
| diffusion | Diffuse T (%) | 65 | 56.8 | 72.5 | 67.2 | 2.2 | 43.94 |
| material | Haze (%) | 77 | 60.9 | 82.0 | 89.8 | 2.3 | 99.29 |
| | YI | 3.903 | 0.341 | 1.585 | 6.379 | 0.53 | 13.0 |
| | b* | −0.184 | −2.091 | −0.408 | 0.982 | −2.018 | 3.6 |

### INDUSTRIAL APPLICABILITY

Since the curable silicone composition of the present invention is cured to form a light diffusion material exhibiting good to excellent transparency and diffusion properties, it is suitable for application as a light diffusing material for optical elements including glass or plastic substrates, e.g., glass or plastic optical housings used in lighting applications, particularly LED or solid state lighting.

1. A curable silicone composition for forming a light diffusion material, said curable silicone composition comprising:
(A) an organopolysiloxane having at least two alkenyl groups per molecule and free of a fluoro-containing organic group;
(B) an organopolysiloxane having at least two silicon atom-bonded hydrogen atoms per molecule and free of a fluoro-containing organic group, in an amount that provides about 0.8 to about 4.0 moles of silicon atom-bonded hydrogen atoms in this component per 1 mole of total alkenyl groups in component (A);
(C) an organopolysiloxane having at least one fluoro-containing organic group per molecule, in an amount of from about 1 to about 40 mass % of total mass of components (A) to (C); and
(D) a catalytic quantity of a hydrosilylation reaction catalyst.

2. The curable silicone composition according to claim 1, wherein component (A) comprises:
(A-1) a linear or a partially branched organopolysiloxane having at least two alkenyl groups per molecule and free of a fluoro-containing organic group, and
(A-2) a resinous organopolysiloxane comprising: SiO_{4/2} units, R¹₂R²SiO_{1/2} units and R¹₃SiO_{1/2} units, wherein each R¹ is an alkyl group, R² is an alkenyl group, and a mole ratio of R¹₂R²SiO_{1/2} units and R¹₃SiO_{1/2} units per SiO_{4/2} units is in a range of from about 0.6 to about 2.0,
wherein a content of component (A-1) is in an amount of from about 50 to about 90 mass % of total mass of components (A-1) and (A-2).

3. The curable silicone composition according to claim 1, wherein component (B) is a resinous organopolysiloxane comprising: SiO_{4/2} units and HR³₂SiO_{1/2} units, wherein each R³ is an alkyl group, and a mole ratio of HR³₂SiO_{1/2} units per SiO_{4/2} units is in a range of from about 1.5 to about 2.5.

4. The curable silicone composition according to claim 1, wherein component (C) has at least one silicon atom-bonded hydrogen atom or alkenyl group per molecule.

5. The curable silicone composition according to claim 1, further comprising:
(E) a hydrosilylation reaction inhibitor, in a sufficient amount to control a curing property of the composition.

6. A light diffusion material obtained by curing the curable silicone composition according to claim 1.

7. The curable silicone composition according to claim 2, wherein component (B) is a resinous organopolysiloxane comprising: SiO_{4/2} units and HR³₂SiO_{1/2} units, wherein each R³ is an alkyl group, and a mole ratio of HR³₂SiO_{1/2} units per SiO_{4/2} units is in a range of from about 1.5 to about 2.5.

8. The curable silicone composition according to claim 7, wherein component (C) has at least one silicon atom-bonded hydrogen atom or alkenyl group per molecule.

9. The curable silicone composition according to claim 8, further comprising:
(E) a hydrosilylation reaction inhibitor, in a sufficient amount to control a curing property of the composition.
